(19) United States
(12) Patent Application Publication
(10) Pub. No.: US 2006/0120455 A1
(43) Pub. Date: Jun. 8, 2006

(54) Apparatus for motion estimation of video data

(76) Inventors: Seong Mo Park, Daejeon-city (KR); Seung Chul Kim, Daejeon-city (KR); Mi Young Lee, Daejeon-city (KR); Han Jin Cho, Daejeon-city (KR); Hee Bum Jung, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/290,651

(22) Filed: Nov. 30, 2005

(30) Foreign Application Priority Data
Dec. 8, 2004 (KR) 10-2004-0103062
Sep. 16, 2005 (KR) 10-2005-0087023

(51) Int. Cl. H04N 11/02; H04N 7/12; H04N 11/04; H04B 1/66

(52) U.S. Cl. 375/240.16; 375/240.12; 375/240.24

(57) ABSTRACT

Provided is an apparatus for motion estimation of video data. The apparatus includes a sum of absolute difference (SAD) calculating unit which receives video data and calculates an SAD for each frame of the video data, a motion vector calculating unit which divides each frame of the video data into macroblocks or sub-macroblocks having a predetermined size and calculates a motion vector estimation value using motion vectors or prediction vectors of macroblocks or sub-macroblocks adjacent to each macroblock or sub-macroblock, and a motion updating unit which performs motion estimation on the video data using an SAD calculated by the SAD calculating unit for the macroblocks or the sub-macroblocks adjacent to each macroblock or sub-macroblock having the predetermined size and the motion vector estimation value of the motion vector calculating unit.

### CROSS-REFERENCE TO RELATED PATENT APPLICATION

This application claims the benefit of Korean Patent Application No. 10-2004-0103062, filed on Dec. 8, 2004 and Korean Patent Application No. 10-2005-0087023, filed on Sep. 16, 2005, in the Korean Intellectual Property Office, the disclosure of which is incorporated herein in its entirety by reference.

### BACKGROUND OF THE INVENTION

1. Field of the Invention

The present invention relates to video data compression, and more particularly, to an apparatus for motion estimation of video data.

2. Description of the Related Art

FIG. 1 is a block diagram of a conventional motion estimation apparatus using a one-pixel greedy search (OPGS) algorithm and a hierarchical search block matching (HSBM) algorithm.

Referring to FIG. 1, the conventional motion estimation apparatus includes a candidate vector prediction unit 100, an algorithm selection unit 110, a motion estimation unit 120, a memory 130, and a half-pixel motion estimation unit 140.

The candidate vector prediction unit 100 receives video data and predicts a candidate vector for a current macroblock to be motion-estimated. At this time, the candidate vector prediction unit 100 selects the best-match motion vector as a candidate motion vector from a zero motion vector, a previous motion vector, and motion vectors of adjacent blocks.

The algorithm selection unit 110 compares a sum of absolute differences (SAD) of the candidate vector predicted by the candidate vector prediction unit 100 with a predetermined threshold to select a motion estimation algorithm. In other words, one of the OPGS algorithm and the HSBM algorithm is selected by the algorithm selection unit 110.

The motion estimation unit 120 performs integer-pixel motion estimation on input video data and outputs a motion vector using one of the OPGS algorithm or the HSBM algorithm selected by the algorithm selection unit 110.

The memory 130 stores the motion vector output from the motion estimation unit 120 and provides the same to the candidate vector prediction unit 100. The half-pixel motion estimation unit 140 performs half-pixel motion estimation on macroblocks and sub-blocks of the input video data by referring to the position of the integer-pixel motion-estimated value of the motion estimation unit 120.

In the conventional motion estimation apparatus of FIG. 1, a motion vector is predicted, motion estimation is performed on a search area that is smaller by an integer than the entire search area according to the OPGS algorithm if a prediction value is within a threshold range, and motion estimation is performed on the entire search area according to the HSNM algorithm if the prediction value is not within the threshold range, thereby improving the efficiency of motion estimation.

However, the conventional motion estimation apparatus includes a separate memory corresponding to each of the OPGS algorithm and the HSNM algorithm. As a result, a large amount of computation is required for motion estimation and thus it is difficult to use the conventional motion estimation apparatus in a real-time video encoder. Moreover, the conventional motion estimation apparatus should include an additional memory for storing motion vectors, which leads to an increase of the size and power consumption thereof. In addition, the use of a fixed algorithm may lead to unnecessary computation in the case of a certain video type or application field, causing reduction of the efficiency of the conventional motion estimation apparatus.

### SUMMARY OF THE INVENTION

The present invention provides an apparatus for efficient motion estimation of video data.

The apparatus includes a sum of absolute difference (SAD) calculating unit which receives video data and calculates an SAD for each frame of the video data, a motion vector calculating unit which divides each frame of the video data into macroblocks or sub-macroblocks having a predetermined size and calculates a motion vector estimation value using motion vectors or prediction vectors of macroblocks or sub-macroblocks adjacent to each macroblock or sub-macroblock, and a motion updating unit which performs motion estimation on the video data using an SAD calculated by the SAD calculating unit for the macroblocks or the sub-macroblocks adjacent to each macroblock or sub-macroblock having the predetermined size and the motion vector estimation value of the motion vector calculating unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional motion estimation apparatus;

FIG. 2 is a block diagram of an apparatus for motion estimation of video data according to the present invention;

FIG. 3 is a block diagram of the apparatus for motion estimation of video data according to the present invention and a peripheral configuration of the apparatus; and

FIGS. 4A through 4I are views for explaining calculation for each mode according to the present invention.

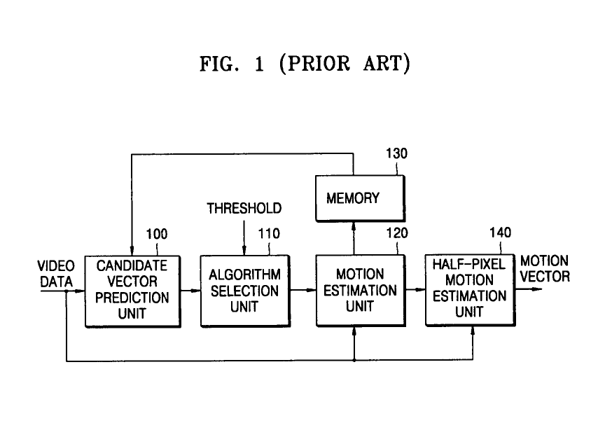

### DETAILED DESCRIPTION OF THE INVENTION

H.264 is a standard under joint development by the Video Coding Expert Group (VCEG) of the International Telecommunications Union (ITU) and the Moving Picture Expert Group (MPEG) of the International Organization for Standardization (ISO). H.264 sets a high compression rate as its main technical goal and is a general-purpose video encoding standard available in almost all types of transmission media such as storage media, the Internet, and satellite broadcasting and environments of various video resolutions.

Traditionally, the ITU has established video encoding standards such as H.261 and H.263 based on cable communication media and the MPEG has established standards for processing moving pictures in storage media or broadcasting media such as MPEG-1 and MPEG-2. The MPEG has finished the establishment of the moving picture standard MPEG-4 which has an important feature of object-based video encoding for achieving various functions and a high compression rate.

The VCEG of the ITU continues to establish a high-compression rate moving picture standard called H.26L after the establishment of MPEG-4. The official comparing experiment of the MPEG shows that H.26L is superior to the MPEG-4 advanced simple profile having a similar function to H.26L in terms of compression rate. Thus, the MPEG and the VCEG agree to jointly develop the JVT video standard called H.264/AVC based on H.26L. H.264/AVC has various superior features among which a method for determining an optimal encoding mode contributes to the improvement of performance.

A module for determining an optimal encoding mode determines an encoding mode for a macroblock that is the basic unit of encoding and motion estimation is the core operation of the module. A macroblock is divided into sub-macroblocks or sub-blocks in a predetermined shape and each sub-block may have a separate motion vector. Unlike a conventional motion estimation method using one reference image, a plurality of reference images can be used to improve compression efficiency. However, those features increase the amount of computation. Therefore, a motion estimation algorithm in H.264/AVC should be designed in consideration of a prediction error and the~amount of computation.

An apparatus for motion estimation of video data according to the present invention can operate according to the H.264 standard and thus an explanation of some technical parts of the apparatus may not be given in the following description.

Hereinafter, a preferred embodiment of the present invention will be described in detail with reference to the accompanying drawings.

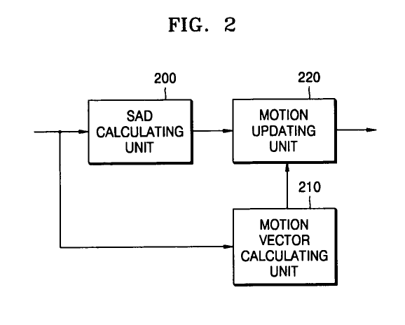

FIG. 2 is a block diagram of an apparatus for motion estimation of video data according to the present invention. The apparatus includes a sum of absolute difference (SAD) calculating unit 200, a motion vector calculating unit 210, and a motion updating unit 220. The SAD calculating unit 200 receives video data and calculates an SAD for each frame. The motion vector calculating unit 210 divides each frame of the video data into macroblocks or sub-macroblocks having a predetermined size and calculates a motion vector estimation value of the macroblocks or the sub-macroblocks using motion vectors or prediction vectors of macroblocks or sub-macroblocks adjacent to each macroblock or sub-macroblock. The motion updating unit 220 performs motion estimation on the video data using an SAD calculated by the SAD calculating unit 200 for the macroblocks or the sub-macroblocks adjacent to each macroblock or sub-macroblock having the predetermined size and the motion vector estimation value of the motion vector calculating unit 210.

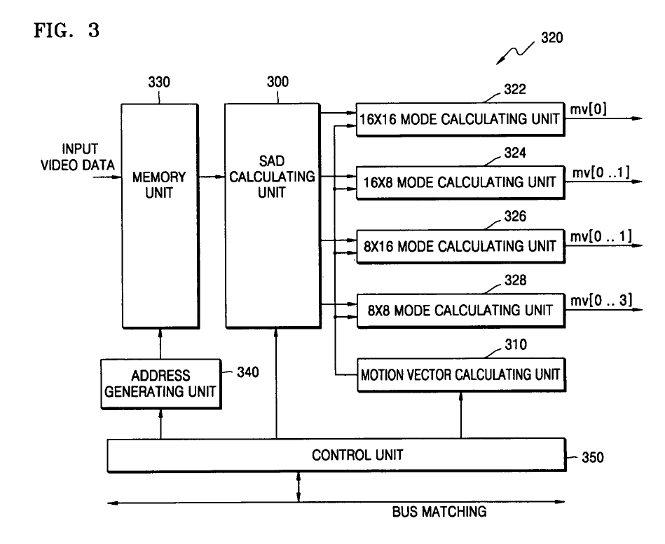

FIG. 3 is a block diagram of the apparatus for motion estimation of video data according to the present invention.

Input video data is stored in a memory unit 330 at an address generated by an address generating unit 340, and the stored video data is input to the SAD calculating unit 300.

The motion updating unit 320 includes a 16×16 mode calculating unit 322, a 16×8 mode calculating unit 324, an 8×16 mode calculating unit 326, and an 8×8 mode calculating unit 328. The 16×16 mode calculating unit 322 divides the video data for which an SAD is calculated into macroblocks of 16×16 pixels and updates motion. The 16×8 mode calculating unit 324 divides 16×16 macroblocks into sub-macroblocks of 16×8 pixels and updates motion. The 8×16 mode calculating unit 326 divides 16×16 macroblocks into sub-macroblocks of 8×16 pixels and updates motion. The 8×8 mode calculating unit 328 divides 16×16 macroblocks into sub-macroblocks of 8×8 pixels and updates motion.

Video data is stored in the memory unit 330 and data transmission from the memory unit 330 to the SAD calculating unit 330 and from the SAD calculating unit 300 and the motion vector calculating unit 310 to the motion updating unit 320 is implemented by the control of a control unit 350. The control unit 350 allows the apparatus for motion estimation of video data according to the present invention to communicate with a system.

The video data may be stored in units of a frame in the memory unit 330. The video data stored in the memory unit 330 may be input to the SAD calculating unit 300 in units of a frame.

The SAD calculating unit 300 receives the video data and calculates an SAD between pixels of two blocks for each macroblock of each frame. At this time, the SAD calculating unit calculates SADs for not only 16×16 macroblocks but also 16×8, 8×16, and 8×8 sub-macroblocks included in the 16×16 macroblocks according to a mode of the motion updating unit 220.

An SAD for each macroblock or sub-macroblock having a predetermined size is provided to a corresponding one of the mode calculating units 322 through 328 of the motion updating unit 320.

The video data stored in the memory unit 330 is also provided to the motion vector calculating unit 310. To show a connection relationship with other components, a connection between the memory unit 330 and the motion vector calculating unit 310 is not indicated in FIG. 3.

The motion vector calculating unit 310 calculates motion vectors for 16×16 macroblocks included in each frame of the video data and 16×8, 8×16, and 8×8 sub-macroblocks included in the 16×16 macroblocks.

The apparatus for motion estimation of video data according to the present invention may be regarded as performing a function of determining an encoding mode because an SAD or a sum of absolute transform differences (SATD) resulting from motion estimation and a motion vector are used in a process of determining an encoding mode.

In the present invention, a rate-distortion (RD) optimization scheme is performed by using the concept of a bit amount for encoding, which is not considered in a low complexity mode, to a high complexity mode. The high complexity mode is used to attain superior compression and error protection performance when complexity is not an issue, e.g., a sufficiently large computational power is given.

The motion vector calculating unit 310 calculates the optimal motion vector using an RD optimization scheme as follows.
J(m, λ_{MOTION})=SA(T)D(s, c(m))+λ_{MOTION}·R(m−p) (1),

where SA(T)D indicates an SAD or an SATD, m=(mₓ,m_{y})^{T} indicates a motion vector, p=(pₓ,p_{y})^{T} indicates a prediction vector, λ_{MOTION} indicates a Lagrangian coefficient (=\sqrt{0.85·2^{OP13}}), the motion vector m=(mₓ,m_{y})^{T} is for a current macroblock or sub-macroblock, the prediction vector p=(pₓ,p_{y})^{T} is obtained by referring to data of a previous block of a current division block (macroblock or sub-macroblock), s indicates a reference image, and c indicates a current image. In other words, c(m) indicates a motion vector for a current image. R(m−p) indicates the number of bits of motion information to be finally encoded. At this time, R is the degree of rate distortion. In other words, R(m−p) is the degree of rate distortion of a vector resulting from a subtraction of the prediction vector from the motion vector.

The SAD in Equation 1 is obtained by the SAD calculating unit 300 as follows.

$$SAD ( s , c ( m ) ) = {\sum }_{x = 1 , y = 1}^{B , B} \vert s [ x , y ] - c [ x - {m}_{x} , y - {m}_{y} ] \vert \qquad ( 2 )$$

Definitions of symbols used in Equation 2 are the same as those used in Equation 1.

At this time, m indicates a motion vector. Since the first division block (macroblock or sub-macroblock) has no adjacent block to be referred to for motion estimation, an arbitrary value or a value for a previous frame may be used as a motion vector. Alternatively, m may be input from the outside of the motion vector calculating unit 310.

In motion estimation, an SATD instead of an SAD is used for mode determination at the position of a fractional pixel instead of an integer pixel. This is because H.264/AVC also transforms a residual signal and then encodes a transform coefficient like the existing international video encoding standards. In other words, when mode determination is based on the calculated SAD, the characteristic of a transformed coefficient is not fully reflected and thus it may not be easy to obtain the optimal motion vector or a spatial prediction mode. Thus, an integer transform adopted in H.264/AVC is more efficient in determining the optimal mode, but a Hadamard transform having a kernel as defined in Equation 3 is used to reduce complexity that may be caused when an SATD is used. The Hadamard transform having a kernel as defined in Equation 3 is performed two-dimensionally, thereby obtaining DiffT and finally obtaining an SATD.

$$H = [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] \qquad ( 3 )$$

DiffT can be obtained as follows using a kernel as defined in Equation 3.
DiffT(x, y)=H[Diff(i, j)] ((x, y)=0 . . . 3 (i, j)=0 . . . 3) (4),

where H[ ] is a Hadamard transform operator. A transformed result is obtained by performing the Hadamard transform vertically and horizontally. An SATD is finally determined as follows.

$$SATD = ( {\sum }_{i , j} \vert DiffT ( i , j ) \vert ) / 2 \qquad ( 5 )$$

A motion vector that minimizes J(m, λ_{MOTION}) is obtained, thereby obtaining the optimal motion vector using the RD optimization scheme.

The SAD calculating unit 300 may divide a 16×16 macroblock into four 8×8 sub-macroblocks and calculate an SAD for each of the 8×8 sub-macroblocks. When an SAD for an 8×8 sub-macroblock is SAD8_{—}8, SADs for the four 8×8 sub-macroblocks may be indicated by SAD8_{—}8[0], SAD8_{—}8[1], SAD8_{—}8[2], and SAD8_{—}8[3]. At this time, the four SADs may be indicated by SAD8_{—}8[0 . . . 3].

The SAD calculating unit 300 includes an SAD calculator for calculating SAD8_{—}8[0 . . . 3] and a buffer for storing SAD8_{—}8 and provides SAD8_{—}8 stored in the buffer to a corresponding one of the mode calculating units 322 through 328 of the motion updating unit 320. The buffer stores four SAD8_{—}8 per candidate vector and provides them to the motion updating unit 320 in parallel, thereby allowing the four mode calculating units 322 through 328 of the motion updating unit 320 to simultaneously operate.

A sum of SAD8_{—}8[0 . . . 3] is provided to the 16×16 mode calculating unit 322. A sum of SAD8_{—}8[0] and SAD8_{—}8[1] and then a sum of SAD8_{'}8[2] and SAD8_{—}8[3] are sequentially provided to the 16×8 mode calculating unit 324. A sum of SAD8_{—}8[0] and SAD8_{—}8[2] and then a sum of SAD8_{—}8[1] and SAD8_{—}8[3] are sequentially provided to the 8×16 mode calculating unit 326. SAD8_{—}8[0], SAD8_{—}8[1], SAD8_{—}8[2], and then SAD8_{—}8[3] are sequentially provided to the 8×8 mode calculating unit 328.

In the present invention, unlike the prior art, motion estimation is performed in parallel on blocks to support parallel operations for blocks using motion vectors of sub-macroblocks or sub-blocks.

In the prior art, motion estimation is performed by sequentially obtaining motion vectors of sub-macroblocks or sub-blocks. For example, in a 16×8 division mode, a motion prediction vector of the second 16×8 sub-macroblock can be obtained only after a motion vector of the first 16×8 sub-macroblock is determined. For this reason, motion vectors of sub-macroblocks or sub-macroblocks are sequentially obtained, causing a critical problem in the implementation of a motion estimation apparatus. A motion estimation apparatus that is the most computationally intensive part of an encoder is-generally implemented as hardware to improve the encoder speed, but it has a speed limitation because it cannot perform parallel motion estimation in a high complexity mode.

To overcome the limitation, in the present invention, the mode calculating units 322 through 328 of the motion updating unit 320 simultaneously operate using the positions of adjacent blocks for motion estimation of video data.

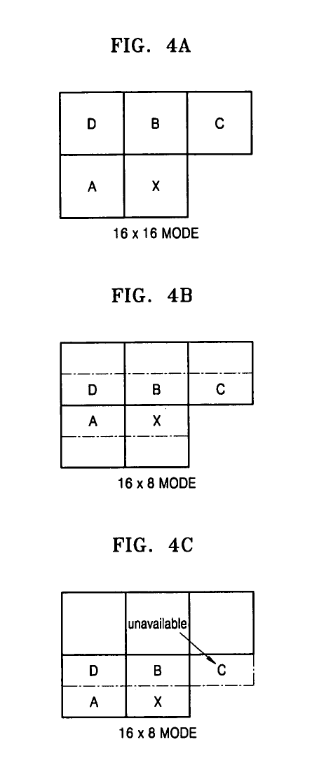

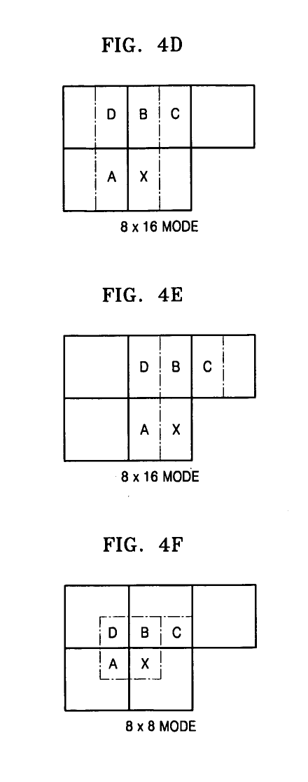

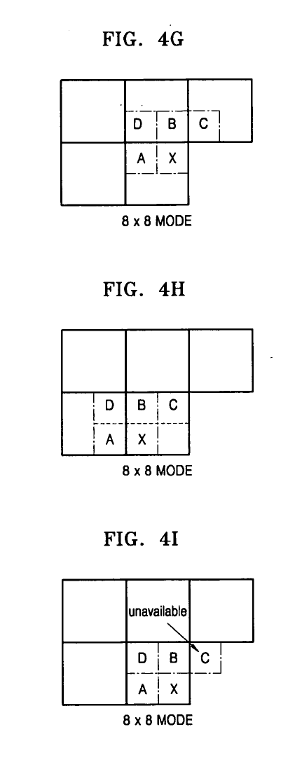

FIGS. 4A through 4I are views for explaining calculation for each mode according to the present invention, in which a bold line indicates the boundary of a macroblock and a dotted line indicates the boundary of a block.

In FIG. 4A, a frame is divided into 16×16 macroblocks. The 16×16 mode calculating unit 322 performs motion estimation in units of a 16×16 macroblock.

When X indicates a current macroblock, motion vectors of a previous image are motion vectors of macroblocks A, B, and C. Motion estimation is performed using a media value of the obtained motion vectors. When the block C is not valid, a block D located at the upper side of the block A is used instead of the block C.

When adjacent blocks or sub-macroblocks are referred to in calculation of a motion vector prediction value or motion estimation, it is preferable that macroblocks or sub-macroblocks located at the upper side, the upper right side, and the left side of a current macroblock or sub-macroblock are referred to. When the motion of an image included in sub-macroblocks is estimated, it is preferable that motion estimation be performed on sub-macroblocks included in a next macroblock after motion estimation is performed on all sub-macroblocks included in a current macroblock.

When the motion of an image included in sub-macroblocks is estimated, if a sub-macroblock that is not yet motion-estimated exists among sub-macroblocks located at the upper side, the upper right side, and the left side of a current sub-macroblock, it is also preferable that motion estimation be performed without reference to the sub-macroblock that is not yet motion-estimated. When the motion of an image included in sub-macroblocks is estimated, if a sub-macroblock included in a macroblock to be processed after a current macroblock having a current sub-macroblock exists among sub-macroblocks located at the upper side, the upper right side, and the left side of the current sub-macroblock, it is also preferable that motion estimation be performed with reference to a sub-macroblock located at the upper left side of the current sub-macroblock, instead of the sub-macroblock included in the macroblock to be processed after the current macroblock.

In FIGS. 4B and 4 C, 16×16 macroblocks are divided into 16×8 sub-blocks. The 16×8 mode calculating unit 324 performs motion estimation in units of a 16×8 sub-block. In FIG. 4B, sub-blocks A, B, C are referred to for motion estimation of a current sub-block X as in FIG. 4A. However, in FIG. 4C, the sub-block C cannot be referred to for motion estimation of the current sub-block X. This is because motion estimation is performed on the current sub-block X after completion of motion estimation of the sub-block B and thus the sub-block C is not yet motion-estimated.

In FIGS. 4D and 4E, 16×16 macroblocks are divided into 8×16 sub-blocks. The 8×16 mode calculating unit 326 performs motion estimation in units of an 8×16 sub-block. In this case, motion estimation is performed on each 8×16 sub-block in the same manner as in FIG. 4A.

In FIGS. 4F through 4H, 16×16 macroblocks are divided into 8×8 sub-blocks. The 8×8 mode calculating unit 328 performs motion estimation in units of an 8×8 sub-block.

In FIGS. 4F through 4H, motion estimation is performed with reference to adjacent blocks like in FIG. 4A. However, in FIG. 41, the current sub-block X is motion-estimated by referring to the sub-block D instead of the sub-block C. In FIG. 4I, motion estimation is performed on the current sub-block X after the sub-blocks D, B and A are motion-estimated. Since the sub-block C is not yet motion-estimated, it is not referred to for motion estimation of the current sub-block X.

Since values of adjacent regions have similarity due to the characteristic of video data, motion estimation according to the present invention can obtain reliable results.

If a vector for motion estimation is obtained from an adjacent block or sub-macroblock and the obtained vector is applied to all division blocks according to the present invention, the apparatus for motion estimation of video data may have a high-complexity configuration similar to a motion estimation apparatus in a low complexity mode.

According to the present invention, the amount of computation and the area or size of each block for motion estimation can be reduced, thereby decreasing power consumption of the apparatus for motion estimation and installation area of the apparatus.

As described above, according to the present invention, the apparatus for motion estimation of video data includes the SAD calculating unit which receives video data and calculates an SAD for each frame of the video data, the motion vector calculating unit which divides each frame of the video data into macroblocks or sub-macroblocks having a predetermined size and calculates a motion vector estimation value using motion vectors or prediction vectors of macroblocks or sub-macroblocks adjacent to each macroblock or sub-macroblock, and the motion updating unit which performs motion estimation on the video data using an SAD calculated by the SAD calculating unit for the macroblocks or the sub-macroblocks adjacent to each macroblock or sub-macroblock having the predetermined size and the motion vector estimation value of the motion vector calculating unit. Since the apparatus according to the present invention can perform motion estimation using adjacent blocks, the size or cost of devices required for implementing the apparatus can be reduced and the apparatus can operate with low power consumption for motion estimation.

It is easily understood by those skilled in the art that operations according to the present invention can be implemented as software or hardware.

While the present invention has been particularly shown and described with reference to an exemplary embodiment thereof, it will be understood by those of ordinary skill in the art that various changes in form and details may be made therein without departing from the spirit and scope of the present invention as defined by the following claims.

What is claimed is:

1. An apparatus for motion estimation of video data, the apparatus comprising:
a sum of absolute difference (SAD) calculating unit receiving the video data and calculating an SAD for each frame of the video data;
a motion vector calculating unit dividing each frame of the video data into macroblocks or sub-macroblocks having a predetermined size and calculating a motion vector estimation value using motion vectors or prediction vectors of macroblocks or sub-macroblocks adjacent to each macroblock or sub-macroblock; and
a motion updating unit performing motion estimation on the video data using an SAD calculated by the SAD calculating unit for the macroblocks or the sub-macroblocks adjacent to each macroblock or sub-macroblock having the predetermined size and the motion vector estimation value of the motion vector calculating unit.

2. The apparatus of claim 1, wherein the motion updating unit divides each frame for which the SAD is calculated into 16×16 macroblocks or divides 16×16 macroblocks into 16×8, 8×16, or 8×8 sub-macroblocks and simultaneously calculates motion vector estimation values for the 16×16 macroblocks or 16×8, 8×16, or 8×8 sub-macro blocks.

3. The apparatus of claim 2, wherein motion estimation is performed on sub-macroblocks included in a next macroblock after motion estimation is performed on all sub-macroblocks included in a macroblock when the motion of an image included in the sub-macroblocks is estimated.

4. The apparatus of claim 2, wherein macroblocks or sub-macroblocks located at the upper side, the upper right side, and the left side of a current macroblock or sub-macroblock are referred to when adjacent blocks or sub-macroblocks are referred to in calculation of the motion vector prediction value or motion estimation.

5. The apparatus of claim 4, wherein motion estimation is performed on sub-macroblocks included in a next macroblock after motion estimation is performed on all sub-macroblocks included in a macroblock when the motion of an image included in the sub-macroblocks is estimated.

6. The apparatus of claim 5, wherein when the motion of an image included in the sub-macroblocks is estimated, if a sub-macroblock that is not yet motion-estimated exists among sub-macroblocks located at the upper side, the upper right side, and the left side of a current sub-macroblock, motion estimation is performed without reference to the sub-macroblock that is not yet motion-estimated.

7. The apparatus of claim 5, wherein when the motion of an image included in the sub-macroblocks is estimated, if a sub-macroblock included in a macroblock to be processed after a current macroblock having a current sub-macroblock exists among sub-macroblocks located at the upper side, the upper right side, and the left side of the current sub-macroblock, motion estimation is performed with reference to a sub-macroblock located at the upper left side of the current sub-macroblock, instead of the sub-macroblock included in the macroblock to be processed after the current macroblock.
